(19) United States
(12) Patent Application Publication
(10) Pub. No.: US 2006/0200385 A1
(43) Pub. Date: Sep. 7, 2006

(54) Electronic marketing system and method

(76) Inventor: William Weston Bray III, Essex, CT (US)

Correspondence Address: ST. ONGE STEWARD JOHNSTON & REENS, LLC, 986 BEDFORD STREET, STAMFORD, CT, 06905-5619, US

(21) Appl. No.: 11/363,738

(22) Filed: Feb. 28, 2006

Related U.S. Application Data
(60) Provisional application No. 60/657,549, filed on Mar. 1, 2005.

(51) Int. Cl. G06Q 30/00

(52) U.S. Cl. 705/14

(57) ABSTRACT

A system and method for improving the sample-to-purchase conversion rate for product samples sent to customers, the system and method utilizing an electronic or computerized format for receiving and/or sending requests and offerings to a customer relating to particular sample product offerings. The sample products are forwarded only to customers that have actually expressed at least a minimum amount of interest in the sample product.

### FIELD OF THE INVENTION

This application claims the benefit of the filing date of U.S. Patent Application Ser. No. 60/657,549 filed Mar. 1, 2005.

### FIELD OF THE INVENTION

The invention relates to a marketing technique for targeting potential customers to send product samples, and more particularly to a pre-selection technique for sending samples to customers via electronic media.

### BACKGROUND OF THE INVENTION

Many marketing techniques have been used over the years. One such technique is the supplying of sample products to potential customers. The benefit of this technique is that it provides an actual sample of the product to the potential customer such that the customer, if interested can make an informed decision to purchase the product.

Therefore, one goal of giving potential customers samples is to encourage them to try the products that they might be interested in purchasing.

However, a problem with this marketing technique is that there is no pre-selection or filtering process of potential customers to identify those that may be interested in the product. In fact, the vast majority of individuals that receive the samples have no interest whatsoever, in purchasing the product. This process then, is very inefficient resulting is a large waste of assets.

Traditional sampling techniques have typically entailed:

1) Mass distribution of samples, most of which are wasted since they are received by customers with no interest in purchasing;

2) Personal delivery of samples at retail, which is relatively expensive and limited in scope or applicability; and

3) “Invitations” to mail in to receive a sample which have very low response rates due to the work involved on the part of the customers.

One key to successful marketing is identification of those individuals that are interested in particular products. Especially is this so in the case of mass distributions of product samples. Therefore, the challenge is to identify which individuals are truly interested in particular products in a cost effective manner taking into account the busy schedules that many individuals keep.

With the advent and growing popularity of the mobile phones, many marketing techniques are changing. For instance, potential customers are being “cold-called” on their phones by marketers in an effort to sell products. This however has had only limited success as individuals are often annoyed by this technique having only a limited amount of calling time on their mobile phone that they may utilize per billing cycle.

Another avenue of advertising is mass email distributions or “spam” as it has come to be known. The escalation of this form of advertising has been viewed as a nuisance to many individuals where individuals often have to deal with hundreds of advertisement emails a day resulting in large amounts of lost time. As a result, many individuals have such a negative view toward such advertising that they delete all such advertisement without reading them. This form of mass emailing to individuals therefore is inefficient having a very low response rate.

Conventional advertising, such as via signage, magazine or newspaper, mass media, or other forms of visual and/or audio communication can reach large numbers of individuals at many differing times of the day. An interested individual may even jot down some information relating to a product sample they desire to obtain. However, with the busy schedules that many individuals keep, such information is often forgotten or misplaced. As there is no means of communicating the customer's interest to the company at that particular time, that potential customer never comes in contact with the company or obtains the desired sample.

What is desired then is a system and method for improving the efficiency in the sending of samples such that the samples are targeted to potential customers that have expressed at least a minimal amount of interest in the product.

It is also desired to provide a system and method for pre-selecting potential customers that have expressed interest in a product prior to sending a sample product to the potential customer.

It is further desired to provide a system and method in which pre-selection of potential customers requires relatively little effort and time on the part of the potential customer.

It is still further desired to provide a system and method that allows an individual to quickly and easily communicate the individual's interest in obtaining a product sample to a company even while traveling.

### SUMMARY OF THE INVENTION

These and other objects are achieved in one advantageous embodiment by the provision of a system for receiving email or text message inquiries from an interested individual via the individual's mobile phone, and for sending a free sample to the individual.

For this application the following terms and definitions shall apply:

The term “data” as used herein means any indicia, signals, marks, symbols, domains, symbol sets, representations, and any other physical form or forms representing information, whether permanent or temporary, whether visible, audible, acoustic, electric, magnetic, electromagnetic or otherwise manifested. The term “data” as used to represent predetermined information in one physical form shall be deemed to encompass any and all representations of the same predetermined information in a different physical form or forms.

The term “network” as used herein includes both networks and internetworks of all kinds, including the Internet, and is not limited to any particular network or inter-network.

The terms “coupled”, “coupled to”, and “coupled with” as used herein each mean a relationship between or among two or more devices, apparatus, files, programs, media, components, networks, systems, subsystems, and/or means, constituting any one or more of (a) a connection, whether direct or through one or more other devices, apparatus, files, programs, media, components, networks, systems, subsystems, or means, (b) a communications relationship, whether direct or through one or more other devices, apparatus, files, programs, media, components, networks, systems, subsystems, or means, and/or (c) a functional relationship in which the operation of any one or more devices, apparatus, files, programs, media, components, networks, systems, subsystems, or means depends, in whole or in part, on the operation of any one or more others thereof.

A growing number of individuals are utilizing mobile devices capable of sending and receiving both email messages and text messaging. Advantageously, such communication via these two avenues typically does not count against a user's allotted minutes or time per billing cycle. Therefore, individuals are more likely to be positively biased to using such forums for sending requests for samples and for receiving offers for such samples.

Therefore, conventional advertising may be used to invite the individual to contact the company via email or text message to receive a free sample. Alternatively, “cold” emails may be sent to individuals soliciting a response to receive a free sample.

This should result in a relatively high sample-to-purchase conversion rate because only interested customers will respond, and relatively high efficiency in the sampling program because samples will only be delivered to customers that have specifically requested them.

In order to accomplish this, it is contemplated that an “opted-in” database of customers may be assembled of those potential customers who wish to receive free samples in the mail. In one advantageous embodiment there may be no cost to the customer to opt-in, but they may be required to provide demographic and psychographic information so that appropriate samples can be offered to them.

In another advantageous embodiment a database of information may be maintained relating to the user including products and product lines the particular individual has expressed interested in. When a free sample of a product becomes available, the system may, based on the individual's demographic information, past requests, or even specific areas of expressed interest, send an email or text message to the individual soliciting a response from the individual as to whether they would like to receive the free sample.

The customers may either be sent targeted samples, or may have sample offers “pushed” to their phones via text messaging. Alternatively, the customer may have set up the system to “pull” sample offerings directed to particular products. In the event that sample offers are “pushed” to the customer, because the customer has opted-in and previously provided their name, address and other information, they need only respond in order for the sample to be sent to them.

In this way a relatively large community of customers that can be demographically sorted, enabling a relatively precise sample delivery resulting in an increased sample-to-purchase ratio.

In one advantageous embodiment, a method for providing a product sample to a customer who is responding to a sample product offering, is provided, the method comprising the steps of presenting a sample product offering to a customer, the product offering soliciting a request from the customer via electronic message, and sending an electronic message via a network connection identifying a particular sample product to be sent to the customer. The method further comprises the steps of receiving the electronic message sent by the customer over the network connection, and analyzing the electronic message to associate the sample product request with a particular sample product. The method still further comprises the steps of sending a sample request to a sample product provider, and forwarding an actual sample product to the customer in response to the sample request.

In another advantageous embodiment, a system for receiving a sample product request sent via an electronic device over a network connection from a customer responding to an advertisement, is provided, the system comprising a sample product request sent by a customer over the network connection with an electronic device, the sample product request identifying a particular product of interest. The system further comprises a processor, for processing the sample product request and associating the sample product request with an available sample product, and a shipping request sent to the product provider, the shipping request identifying a particular sample product to be sent to a customer. The system is provided such that an actual sample product corresponding to the sample product request is sent to the customer.

In still another advantageous embodiment, a method for providing a product sample to a customer responding to a sample product offering is provided, the method comprising the steps of presenting a sample product offering to a customer, the product offering soliciting a request from the customer via electronic message, and sending an electronic message via a network connection identifying a sample product to be sent to the customer. The method further comprises the steps of receiving the electronic message sent by the customer over the network connection, associating the sample product request with a particular sample product, and forwarding an actual sample product to the customer in response to the sample request.

In yet another advantageous embodiment, a system for receiving a sample product request from a customer via an electronic device over a network connection and for providing a sample product to the customer is provided comprising a sample product offering sent to a customer over the network connection to an electronic device, and a sample product request sent by a customer over the network connection in response to the sample product offering. The system further comprises a processor for associating the sample product request with a sample product offering, and a shipping request sent to a product provider corresponding to the sample product request. The system is provided such that the sample product request is in the form of an email or a text message.

Other objects of the invention and its particular features and advantages will become more apparent from consideration of the following drawings and accompanying detailed description.

### BRIEF DESCRIPTION OF THE DRAWINGS

FIG. 1 is a block diagram of one advantageous embodiment of the present invention.

FIG. 2 is a block diagram of another advantageous embodiment of the present invention according to FIG. 1.

FIG. 3 is a flow diagram of the embodiment according to FIG. 1.

FIG. 4 is a flow diagram of the embodiment according to FIG. 2.

FIG. 5 is another flow diagram of the embodiment according to FIG. 2.

### DETAILED DESCRIPTION OF THE INVENTION

Referring now to the drawings, wherein like reference numerals designate corresponding structure throughout the views.

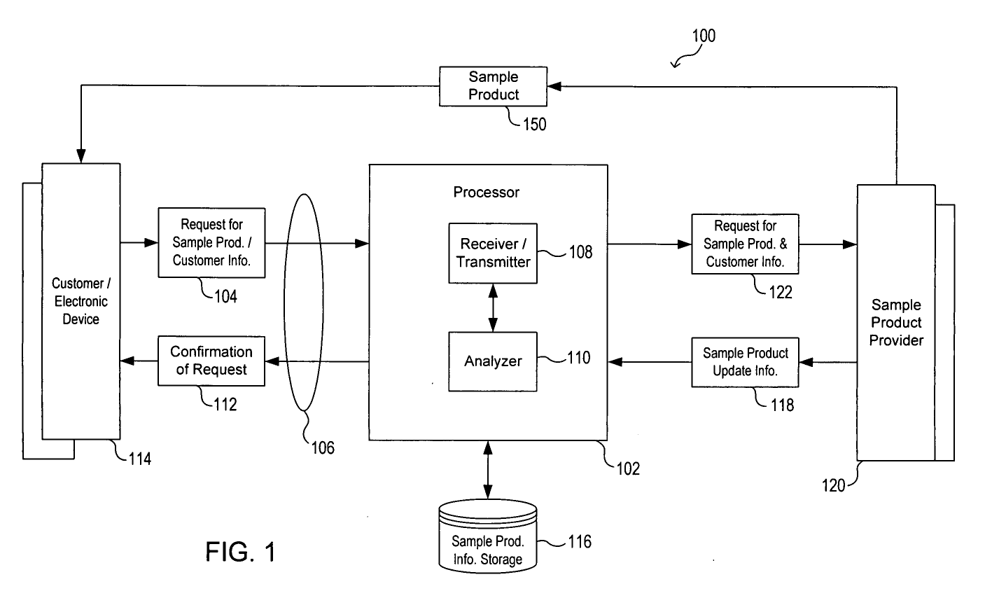

FIG. 1 is a block diagram depicting one advantageous embodiment of system 100. System 100 includes processor 102, which is provided to receive a request 104 for a particular sample product via a network connection 106. It is contemplated that request 104 may further comprise customer information, including, for example, the name and address of the customer to whom the sample product 150 is to be shipped. It is further contemplated that request 104 may also comprise a sample product identifier, such as a code, unique to or that may be associated with a sample product(s) that may be desired.

In one advantageous embodiment, system 100 is further provided with receiver/transmitter 108 coupled with analyzer 110. Receiver/transmitter 108 is provided, for example, to receive request 104. Upon receipt of request 104, receiver/transmitter 108 may send a confirmation 112 of receipt of the request to the customer/electronic device 114. Receiver/transmitter 108 may further send request 104 to analyzer 110. Analyzer 110 may then analyze the particular request to match it with a particular sample product offering and/or a sample product provider 120.

For example, system 100 may be provided with sample product information storage 116, which may be used to store information relating to sample product offerings. It is contemplated that a sample product provider 120 may provide sample product update information 118 relating to various sample product offerings. The update information 118 is received by processor 102 and subsequently saved in sample product information storage 116. Upon receipt of a request 104, analyzer 110 need only access sample product information storage 116 to determine if the requested sample product is available. If so, a request for a sample product 122 is sent to the corresponding sample product provider 120. The request for a sample product 122 may further comprise the customer name and address so that the sample product provider 120 may forward the sample product 150 accordingly.

It is contemplated that the customer / electronic device may comprise, for example, a mobile phone or device that is capable of sending and/or receiving email and/or text messages. In this manner, once a customer comes into contact with an advertisement offering a free sample product, the customer need only send an electronic request 104 to the system 100 via the network connection 106 requesting the free sample product 150.

This method of sending sample products 150 is highly desirable because the result should be a relatively high sample-to-purchase conversion rate because only interested customers will request the sample product 150 and samples will only be delivered to customers that have specifically requested them.

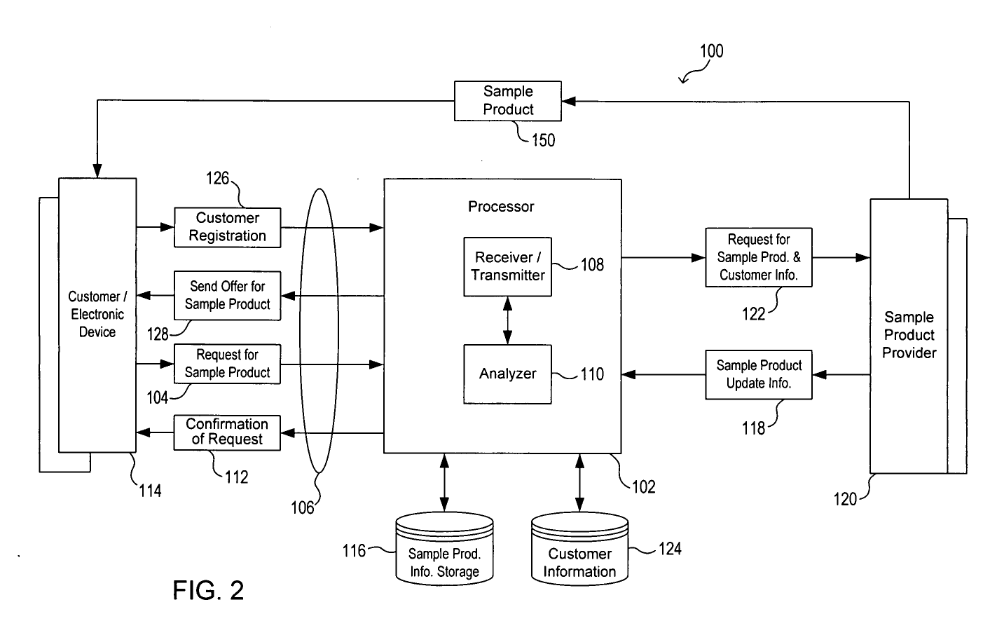

Turning now to FIG. 2, a variation of system 100 is illustrated. In this advantageous embodiment, system 100 is further provided with a customer information storage 124, which is used to store customer information.

In this application, the customer may opt-in by sending processor 102 customer registration 126, which comprises information relating to the customer. It is contemplated that the registration may be free of charge, but the customer may be required to provide demographic and psychographic information. Based upon the customer information, the analyzer 110 can analyze current sample product offerings and send an offer for a sample product 128 to customer / electronic device 114 that is appropriate for the customer. It is further contemplated that customer information storage 124 may also be used to store sample product requests 104 received from the particular customer to obtain a more accurate profile of the particular customer to aid in the selection of future sample product offerings.

Again, while system 100 has been discussed in connection with an electronic device such as a mobile telephone, it is contemplated that any electronic device capable of receiving and/or sending computerized messages may be utilized to accomplish the pushing and/or pulling of sample offers to the customers, including but not limited to e-mail, interactive devices such as touch screen devices and/or interactive television and such.

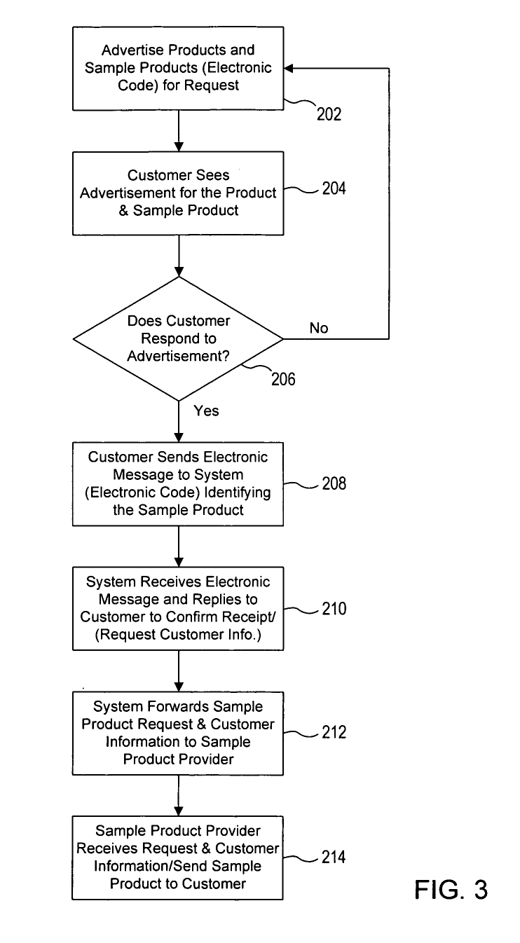

Referring now to FIGS. 3-5, various flow diagrams of advantageous embodiments of system 100 are illustrated according to FIGS. 1-2.

For example, FIG. 3 begins with the initial step of advertise products and free product samples 202. This type of advertising may comprise virtually any conventional known advertising means, whether visual, audio, electronic or otherwise. It is further contemplated that the advertisement may comprise a product sample code listed thereon. Once the customer sees the advertisement for the product sample 204, the customer may then respond to the advertisement 206 via an electronic device as previously discussed herein.

If the customer does decide to respond, the customer may send an electronic or computerized message to the system 208. If the advertisement included a product sample code, the customer may also include this code to aid the system in processing the request. If is further contemplated that, if this is an initial contact by the customer, the customer may also include their name and/or address for receipt of the sample.

Upon receipt of the sample product request, the system 100 may provide confirmation 210 to the customer of receipt of the request. Alternatively, if this is an initial contact by the customer, the system 100 may further prompt the customer to supply customer information including the customer's name and address for shipping purposes.

The system 100, upon identification of the sample request, may then send a request 212 to the appropriate sample provider including the customer information, such as the customer's name and address. The sample product provider receives the sample product request 214 and may then forward the sample product, if available, to the customer as requested.

It should be noted that, while various functions and methods have been described and presented in a sequence of steps, the particular sequence has been provided merely as an illustration of one advantageous embodiment (FIGS. 3-5), and that it is not necessary to perform these functions in the specific order illustrated. It is further contemplated that any of these steps may be moved and/or combined relative to any of the other steps. In addition, it is still further contemplated that it may be advantageous, depending upon the application, to utilize all or any portion of the functions described herein.

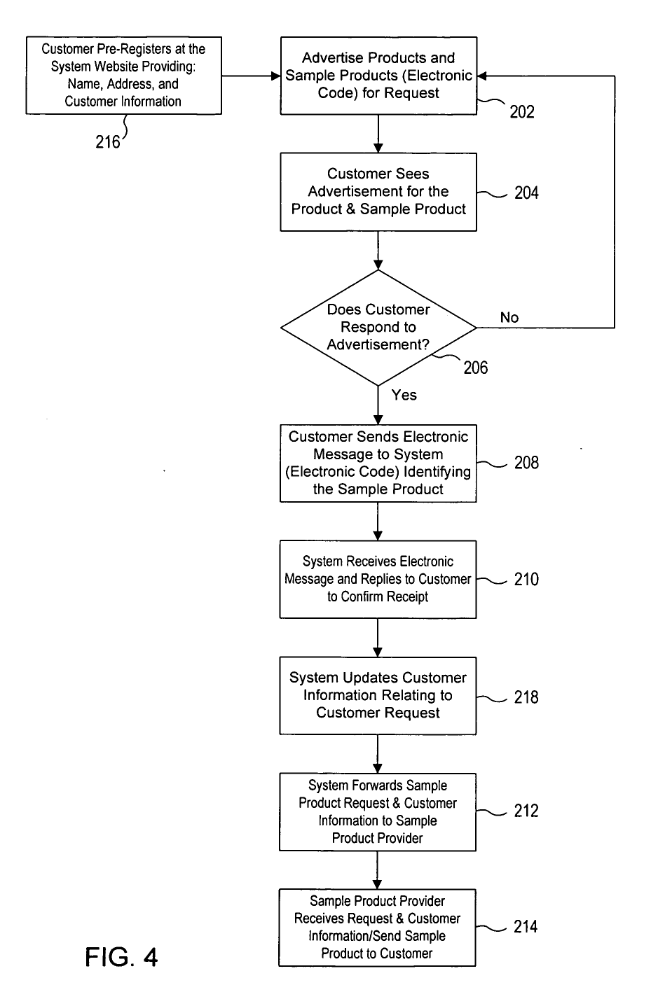

FIG. 4 is similar to the flow chart illustrated in FIG. 3 except the step of pre-registering 216 at, for example, the system 100 website is initially provided. The pre-registration step may include, for example, providing the customer's name, address, and may even comprise providing demographic and psychographic information. In this case, system 100, upon receipt of a request 210, need not request customer information as such data is already available because of the pre-registration process.

Once the system 100 receives the request 210, the system 100 may then include the step of updating the customer information relating to the customer request 218. In this manner, the system 100 is able to obtain a more accurate profile of that particular customer based upon their past sample product requests.

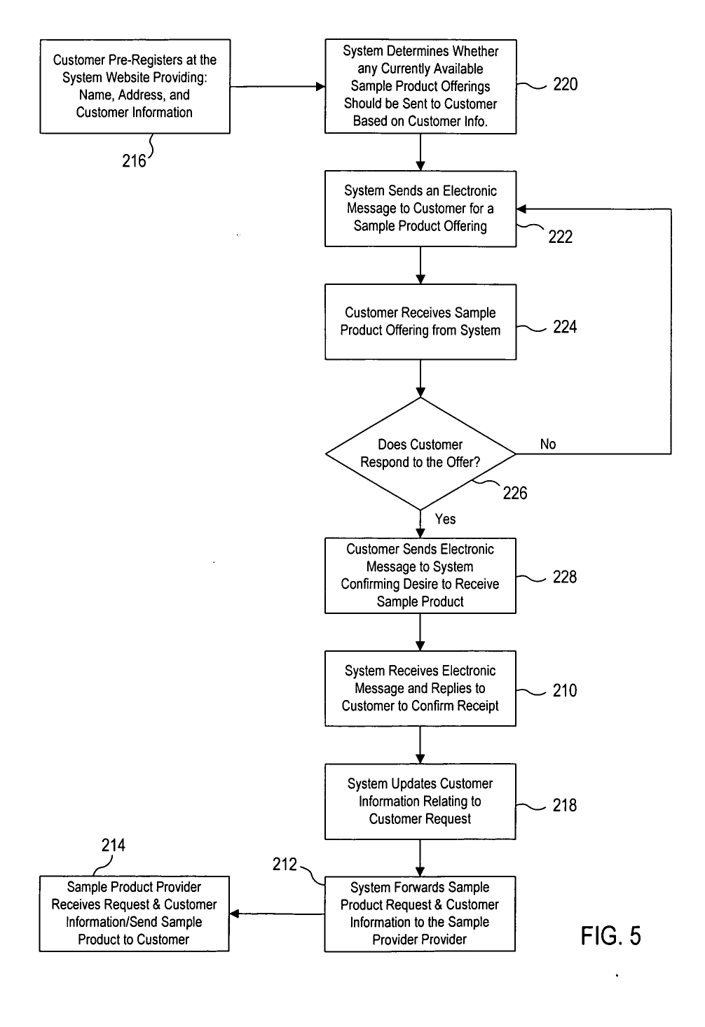

An alternative embodiment of system 100 is illustrated in FIG. 5. Initially, the customer pre-registers 216 with the system as described in connection with FIG. 4. The system may then determine whether a currently available product sample offerings should be sent 220 to the customer. The system may utilize the customer information including demographic, psychographic and any previous sample product requests made by the customer to make this determination.

Once system 100 determines that a product offering should be sent 220 to the customer the system 100 sends an electronic message to the customer 222 regarding such. The customer then receives the product offering 224, and must determine whether they are interested in receiving the sample product 226.

If the customer decides that they do wish to receive the sample product, the customer sends an electronic message to the system 228 confirming such. In the case of an email or text message, the customer may simply reply to the message indicating “yes” or it is contemplated that the system may be set up so that the customer simply indicates “reply” and such a reply is taken as a positive indication to receive the sample product. In any event, once the customer has registered with the system, it is contemplated that the system 100 may be programmed or set up to minimized as much as possible, the time required to be spent by the customer to request a particular sample product.

It is still further contemplated that the system 100 may send a composite offering of a number of samples, or even an invitation to visit the website for a selected of offerings highlighted for the particular customer.

Therefore, the system 100 addresses many of the problems associated with mass distribution of product samples. For example, only sample products are sent to customers that have already expressed interest in receiving the sample product. This should result in an increased sample-to-purchase conversion rate. In addition, the personal delivery of product samples to retail locations can be eliminated as the process is completed over a network connection. Finally, invitations sent by conventional mail to receive a sample, which are costly and have very low response rates may be eliminated, while the amount of “work” required by the customer is minimized.

Although the invention has been described with reference to a particular arrangement of parts, features and the like, these are not intended to exhaust all possible arrangements or features, and indeed many other modifications and variations will be ascertainable to those of skill in the art.

What is claimed is:

1. A method for providing a product sample to a customer responding to a sample product offering, the method comprising the steps of:
presenting a sample product offering to a customer, the product offering soliciting a request from the customer via electronic message;
sending an electronic message via a network connection identifying a particular sample product to be sent to the customer;
receiving the electronic message sent by the customer over the network connection;
associating the sample product request with a particular sample product;
sending a sample request to a sample product provider; and
forwarding an actual sample product to the customer in response to the sample request.

2. The method according to claim 1 wherein the step of receiving a product request further includes the step of receiving customer information relating to the customer.

3. The method according to claim 2 wherein the customer information is selected from the group consisting of: name, address, demographic information, psychographic information, and combinations thereof.

4. The method according to claim 2 further comprising the step of storing the received customer information.

5. The method according to claim 1 wherein the step of presenting a sample product offering to a customer further comprises the step of presenting a sample product identifier corresponding to the particular product offering.

6 The method according to claim 5 wherein the step of sending an electronic message via a network connection further comprises the step of including the product identifier to identify the particular sample product to be sent to the customer.

7. The method according to claim 1 further comprising the step of receiving and storing sample product information updates relating to various sample products for distribution to the customer.

8. The method according to claim 1 further comprising the step of sending a message to the customer to confirm receipt of the sample product request.

9. The method according to claim 1 further comprising the step of receiving customer and registration information from a customer.

10. The method according to claim 9 further comprising the step of sending a sample product offer to the customer based on the customer and registration information.

11. The method according to claim 1 wherein the step of receiving a sample product request further comprising the step of receiving a sample product identifier that matches to a particular sample product.

12. A system for receiving a sample product request sent via an electronic device over a network connection from a customer responding to an advertisement, the system comprising:
a sample product request sent by a customer over the network connection with an electronic device, the sample product request identifying a particular product of interest;
a processor, for processing said sample product request and associating said sample product request with an available sample product;
a shipping request sent to the product provider, said shipping request identifying a particular sample product to be sent to a customer
wherein an actual sample product corresponding to said sample product request is sent to the customer.

13. The system according to claim 12 further comprising customer information sent by the customer and stored in a customer information storage.

14. The system according to claim 13 wherein the customer information is selected from the group consisting of: name, address, demographic information, psychographic information, and combinations thereof.

15. The system according to claim 12 further comprising a sample product identifier corresponding to a particular product offering.

16 The system according to claim 15 wherein said sample product request includes said product identifier to identify the particular sample product to be sent to the customer.

17. The system according to claim 12 further comprising a sample product information update saved on said sample product storage, said sample product information update relating to various sample products for distribution to the customer.

18. The system according to claim 12 further comprising a confirmation message sent to the customer to confirm receipt of said sample product request.

19. The system according to claim 12 wherein said processor further comprises an analyzer for analyzing said sample product request to determine which particular sample product offering matches said sample product request.

20. The system according to claim 12 further comprising customer and registration information stored in a customer information storage.

21. The system according to claim 20 wherein said processor further comprises an analyzer for analyzing said customer and registration information to determine which particular sample product offerings to forward to the customer.

22. The system according to claim 21 further comprising a sample product offer sent to the customer based on the customer and registration information.

23. The system according to claim 12 wherein a format of said sample product request is selected from the group consisting of; an email, a text message and combinations thereof.

24. The system according to claim 12 wherein the electronic device comprises a mobile telephone.

25. A method for providing a product sample to a customer responding to a sample product offering, the method comprising the steps of:
presenting a sample product offering to a customer, the product offering soliciting a request from the customer via electronic message;
sending an electronic message via a network connection identifying a sample product to be sent to the customer;
receiving the electronic message sent by the customer over the network connection;
associating the sample product request with a particular sample product; and
forwarding an actual sample product to the customer in response to the sample request.

26. A system for receiving a sample product request from a customer via an electronic device over a network connection and for providing a sample product to the customer comprising:
a sample product offering sent to a customer over the network connection to an electronic device;
a sample product request sent by a customer over the network connection in response to said sample product offering;
a processor for associating said sample product request with a sample product offering;
a shipping request sent to a product provider corresponding to said sample product request;
said sample product request being in the form of an email or a text message.

27. The system according to claim 26 wherein said sample product request further comprises a sample product identifier corresponding to a particular product offering.
